(19) United States
(12) Patent Application Publication
(10) Pub. No.: US 2005/0117905 A1
(43) Pub. Date: Jun. 2, 2005

(54) Optical transponder which can be reconfigured in accordance with various types of client networks

(76) Inventors: Joon Ki Lee, Daejeon-city (KR); Seung Il Myong, Daejeon-city (KR); Yun Hee Cho, Daejeon-city (KR); Jyung Chan Lee, Daejeon-city (KR); Kwangjoon Kim, Daejeon-city (KR); Yool Kwon, Busan-city (KR); Youn Seon Jang, Daejeon-city (KR); Moo Jung Chu, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/917,095

(22) Filed: Aug. 11, 2004

(30) Foreign Application Priority Data
Nov. 27, 2003 (KR) 2003-84984

(51) Int. Cl. H04J 14/02

(52) U.S. Cl. 398/79

(57) ABSTRACT

An optical transponder which can be reconfigured in accordance with various types of client networks is provided. A client network interface transceiver includes a connector comprising a first connection terminal providing a unit transmitting and receiving a plurality of first clock signals, a plurality of second clock signals, and a plurality of data signals to and from the digital wrapper; a second connection terminal providing a unit transmitting and receiving a supervision/control signal and a CPU-related signal to and from the supervision/controlling unit; and a power source terminal providing a unit to which a power source is supplied. The client network interface transceiver multiplexes a client signal transmitted from the client network or demultiplexes a signal transmitted from an optical transmission network, outputs the client signal and the signal, and can be replaced through a front panel of the optical transponder line card in accordance with types of client networks.

This application claims the priority of Korean Patent Application No. 2003-84984, filed on Nov. 27, 2003, in the Korean Intellectual Property Office, the disclosure of which is incorporated herein in its entirety by reference.

### BACKGROUND OF THE INVENTION

1. Field of the Invention

The present invention relates to an optical transponder having a unified platform which can be reconfigured in accordance with various types of client networks, and more particularly, to an optical transponder which receives client signals including a synchronous digital hierarchy/synchronous optical network (SDH/SONET) signal, a gigabit Ethernet (GbE) signal, and a storage area network (SAN) signal.

2. Description of the Related Art

FIG. 1 shows a configuration of a conventional optical transponder which converts an STM-64/OC-192 signal that is most widely used, into an OTU2 signal and transmits the OTU2 signal. Referring to FIG. 1, the conventional optical transponder, which cannot be reconfigured in accordance with various types of client networks and receives the STM-64/OC-192 signal, includes an STM-64 interface transceiver 110, a digital wrapper unit 120, an OTN interface transceiver 130, and a supervision/ control unit 140.

The STM-64 interface transceiver 110 is a unit into which an STM-64/OC-192 signal is input or which outputs the STM-64/OC-192 signal. The STM-64 interface transceiver 110 includes an optic/electric conversion block 112, a multiplexing/demultiplexing block 114. The optic/electric conversion block 112 optic-to-electric converts the STM-64/OC-192 signal. The multiplexing/demultiplexing block 114 converts a 9.958 Gb/s serial electric signal into 16×622 MHz parallel data and a 622 MHz clock signal.

The digital wrapper unit 120 maps or demaps the STM-64/OC-192 signal into the OTU2 signal. The digital wrapper unit 120 includes an OTN clock generation block 122, an SDH clock generation block 126, and a digital wrapper 124. The OTN clock generation block 122 generates a clock signal for mapping, and the SDH clock generation block 126 generates a clock signal for demapping. The digital wrapper 124 maps the STM-64/OC-192 signal into the OTU2 signal or demaps the OTU2 signal into the STM-64/OC-192 signal.

The OTN interface transceiver 130 is a unit into which the OTU2 optical signal is input or which outputs the OUT2 optical signal. The supervision/control unit 140 controls the operation of each element constituting the STM-64 interface transceiver 110 and supervises a performance or abnormality thereof. The OTN interface transceiver 130 includes a multiplexing/demultiplexing block 132 and an optic/electric conversion block 134. The multiplexing/demultiplexing block 132 converts 16×669 MHz parallel data and a 669 MHz clock signal input from the digital wrapper unit 120 into a 10.7 Gb/s serial electric signal. The optic/electric conversion block 134 optic-to-electric converts the 10.7 Gb/s serial electric signal.

Each of the STM-64 interface transceiver 110 and the OTN interface transceiver 130 includes 300-pin multisource agreement (MSA) standard connectors 116 and 136. 16 parallel data, one clock signal, and a supervision/control signal are exchanged with one another via the 300-pin MSA standard connectors 116 and 136, and a power source is supplied to a transceiver via the 300-pin MSA standard connections 116 and 136. A method of exchanging the 16 parallel data and the one clock signal are exchanged with each other via the 300-pin MSA standard connectors 116 and 136 is defined in an optical internetworking forum (OIF) and is referred to as a serdes framer interface level 4 (SFI-4) connection standard.

However, in the aforementioned conventional optical transponder, types of optical transponders are different according to types of client networks. Thus, when a connected client signal should be changed, a system operator should replace an optical transponder with another one and a manufacturer should manufacture and manage various types of optical transponder PCBs.

### SUMMARY OF THE INVENTION

The present invention provides an optical transponder which can be reconfigured and reused by replacing only the client network interface board and then re-provisioning the transponder when an interfaced client signal varies.

According to an aspect of the present invention, there is provided an optical transponder comprising: a client network interface transceiver multiplexing a client signal transmitted from a client network or demultiplexing a signal transmitted from an optical transport network and outputting the multiplexed signal and the demultiplexed signal; a digital wrapper mapping an STM-64/OC-192 signal or a plurality of STM-16/OC-48 signals input from the client network interface transceiver into an OTU2 signal or demapping the OTU2 signal into the STM-64/OC-192 signal or the plurality of STM-16/OC-48 signals, including a plurality of client network clock generation units to provide a second clock signal needed in the client network interface transceiver; an OTN interface transceiver transmitting the OTU2 signal input from the optical transport network to the digital wrapper or transmitting the OTU2 signal input from the digital wrapper to the optical transport network; and a supervision/control unit initializing and resetting hardware according to types of client signals input into the client network interface transceiver from the client network and supervising performance of each element and occurrence of errors, wherein the client network interface transceiver includes a connector comprising a first connection terminal providing a unit transmitting and receiving a plurality of first clock signals, a plurality of second clock signals, and a plurality of data signals to and from the digital wrapper; a second connection terminal providing a unit transmitting and receiving a supervision/control signal and a CPU-related signal to and from the supervision/controlling unit; and a power source terminal providing a unit to which a power source is supplied and is combined to be attached or detached to or from the digital wrapper and the supervision/controlling unit.

Thus, a functional unit commonly needed in the optical transponder is shared and only the client network interface board according to types of client signals is replaced with another one so that communication service provider and equipment manufacturer can reduce costs.

### BRIEF DESCRIPTION OF THE DRAWINGS

The above aspects and advantages of the present invention will become more apparent by describing in detail exemplary embodiments thereof with reference to the attached drawings in which:

FIG. 1 shows a configuration of a conventional optical transponder which converts an STM-64/OC-192 signal that is most widely used, into an OTU2 signal and transmits the OTU2 signal;

FIG. 2 shows a configuration of a wavelength division multiplexing (WDM) optical transmission equipment using an optical transponder which can be reconfigured in accordance with various types of client networks, according to the present invention

FIG. 3 is a block diagram showing a configuration of an optical transponder which can be reconfigured in accordance with various types of client networks, according to an embodiment of the present invention; and

FIGS. 4 through 6 show a detailed configuration of the optical transponder and connection between elements when a client signal input from a client network is an STM-64/OC-192 signal, an STM-16/OC-48 signal, and a GbE/SAN signal, respectively.

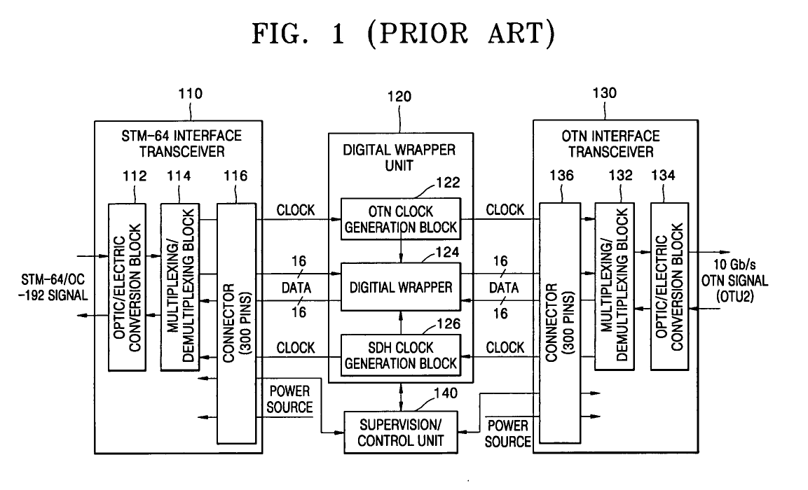

### DETAILED DESCRIPTION OF THE INVENTION

Hereinafter, exemplary embodiments of the present invention will be described in detail with reference to the accompanying drawings.

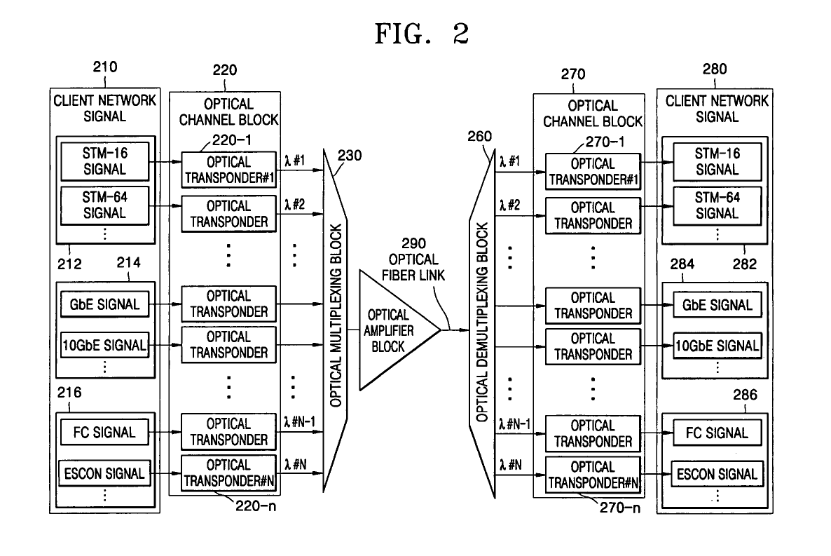

FIG. 2 shows a configuration of a wavelength division multiplexing (WDM) optical transmission equipment using an optical transponder which can be reconfigured in accordance with various types of client networks, according to the present invention. The WDM optical transmission equipment is a device which dramatically increases the efficiency of a bandwidth utilization of an optical fiber link, that is, transmission capacity, by multiplexing and transmitting optical signals divided into different wavelengths in an optical transmission network.

Referring to FIG. 2, the WDM optical transmission equipment includes an optical channel block 220, an optical multiplexing block 230, and an optical amplifier block 240, an optical demultiplexing block 260 and an optical channel block 270. The optical multiplexing block 230 and the optical demultiplexing block 260 are connected to each other via an optical fiber link 290.

The optical channel block 220 converts a client signal input from an external client network 210 into a WDM optical channel having the wavelength stipulated in accordance with ITU-T recommendation. The optical multiplexing block 230 multiplexes the optical signal input from the optical channel block 220. The optical amplifier block 240 amplifies the optical signal multiplexed by the optical multiplexing block 230 via an optical fiber. The optical signal amplified by the optical amplifier block 240 is transmitted to the optical demultiplexing block 260 via the optical fiber link 290. The optical demultipexing block 260 demultiplexes the optical signal transmitted via the optical fiber link 290. The optical channel block 270 converts the optical signal demultiplexed for each WDM optical channel by the optical demultiplexing block 260 into a client signal of the external client network 280.

Client signals which the WDM optical transmission equipment receives include a synchronous digital hierarchy/synchronous optical network (SDH/SONET) signal 212 including an STM-16/OC-48 signal and an STM-64/OC-192 signal, a gigabit Ethernet signal 214 including a GbE signal and a 10GbE signal, and an SAN signal 216 including a fiber channel (FC) signal and enterprise systems connectivity (ESCON) signal. In FIG. 2, #N is the maximum number of optical channels which the WDM optical transmission equipment receives, and N has values of 8, 16, 32, 40, and 160.

The optical transponder which can be reconfigured in accordance with various types of client networks according to the present invention, belongs to the optical channel blocks 220 and 270 of the WDM optical transmission equipment shown in FIG. 2 and connects the external client network 210 or 280 to the optical multiplexing block 230 or the optical demultiplexing block 260. An optical transponder in the conventional WDM optical transmission equipment has developed to receive the SDH/SONET signal, such as the STM-16/OC-48 signal and the STM-64/OC-192 signal. However, due to the recent and explosive increase in data communication traffic, demands for interfacing various clients signal, such as GbE, FC, and ESCON increase. In addition, as the speed of an optical channel of the WDM optical transmission equipment increases from 2.5 Gb/s to 10 Gb/s, four STM-16/OC-48 signals are multiplexed, or a plurality of GbE and SAN signals are multiplexed into a 10 Gb/s OTN (OTU2) signal to transmit them so that researches on the improvement of the efficiency of an optical channel bandwidth exploitation of the WDM optical transmission equipment has been progressed.

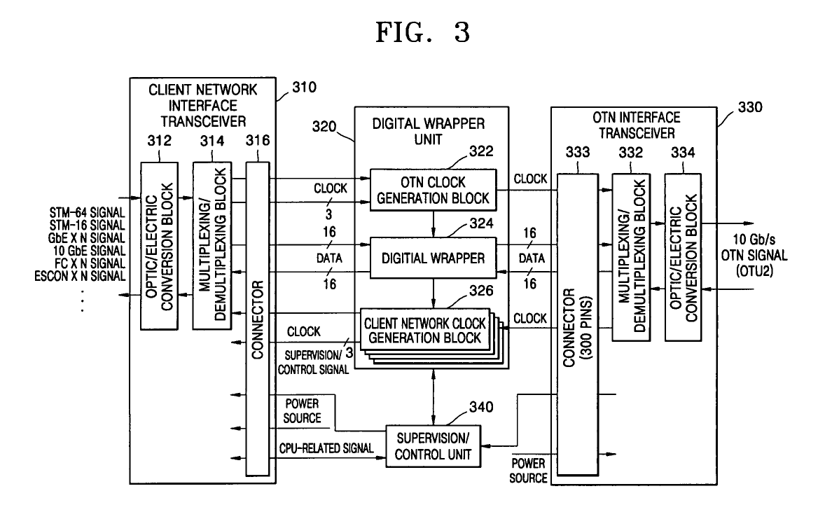

FIG. 3 is a block diagram showing a configuration of an optical transponder which can be reconfigured in accordance with various types of client networks, according to an embodiment of the present invention. The optical transponder 300 of FIG. 3 includes a client network interface transceiver 310, a digital wrapper unit 320, an OTN interface transceiver 330, and a supervision/control unit 340. The client network interface transceiver 310 is combined with the optical transponder 300 to be replaced, and transceivers having different configurations are used in response to signals input from client networks. The client network interface transceiver 310 includes an optic/electric conversion block 312, a multiplexing/demultiplexing block 314, and a connector 316. The optic/electric conversion block 312 optic-to-electric converts a client signal input from a client network. The multiplexing/demultiplexing unit block 314 converts an electric signal input from the optic/electric conversion block 312 into a parallel data signal and a clock signal. The connector 316 includes a first connection terminal which provides a unit transmitting and receiving a plurality of first clock signals (clock signals output to the OTN clock generation block 322), a plurality of second clock signals (clock signals input from a client network clock generation block 326), and a plurality of data signals to and from the digital wrapper unit 320, a second connection terminal which provides a unit transmitting and receiving a supervision/control signal and a CPU-related signal to and from the supervision/control unit 340, and a power source terminal which provides a unit to which a power source is supplied.

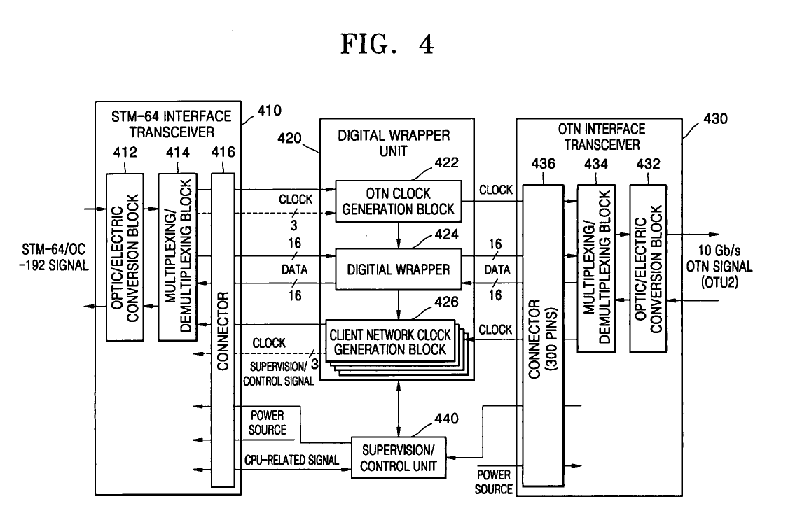

FIGS. 4 through 6 show the detailed configuration of the optical transponder 310 and connection between elements when a client signal input from a client network is an STM-64/OC-192 signal, an STM-16/OC-48 signal, and a GbE/SAN signal, respectively.

Referring to FIG. 4, when an STM-64 interface transceiver 410 as the client network interface transceiver 310 is mounted on the optical transponder 300, 16 data and one clock signal are transmitted to a digital wrapper unit 420 and a supervision/control unit 440 according to a serdes framer interface level 4 (SFI-4) connection standard. Only a clock signal generated by one client network clock generation unit of the four client network clock generation units 423 of the digital wrapper unit 420 is used. Three clock signals and a CPU-related signal indicated by dotted lines of FIG. 4 are not used.

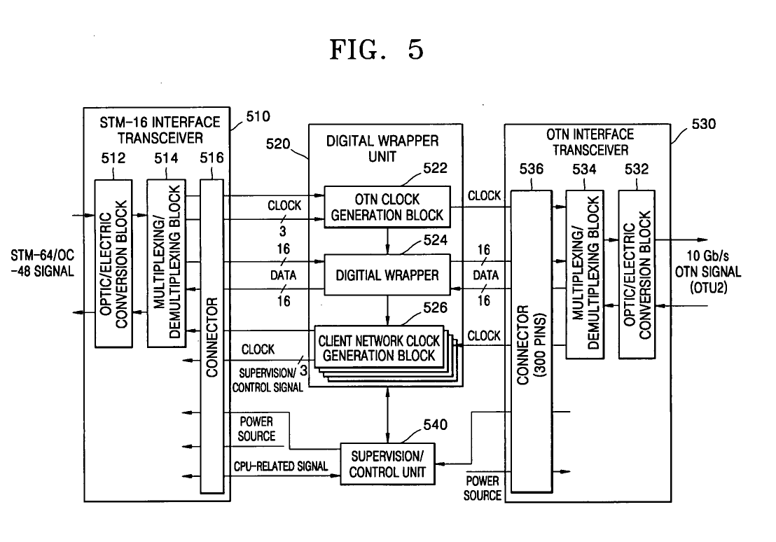

In addition, referring to FIG. 5, when an STM-16 interface transceiver 510 as the client network interface transceiver 310 is mounted on the optical transponder 300, four signals can be input into an STM-16 interface transceiver 510. Thus, 16 data and four clock signals are transmitted to a digital wrapper unit 520 and a supervision/control unit 540. Since the four signals are in an asynchronous state, the four clock signals and a client network clock generation unit 523 are used. A CPU-related signal indicated by a dotted line of FIG. 5 is not used.

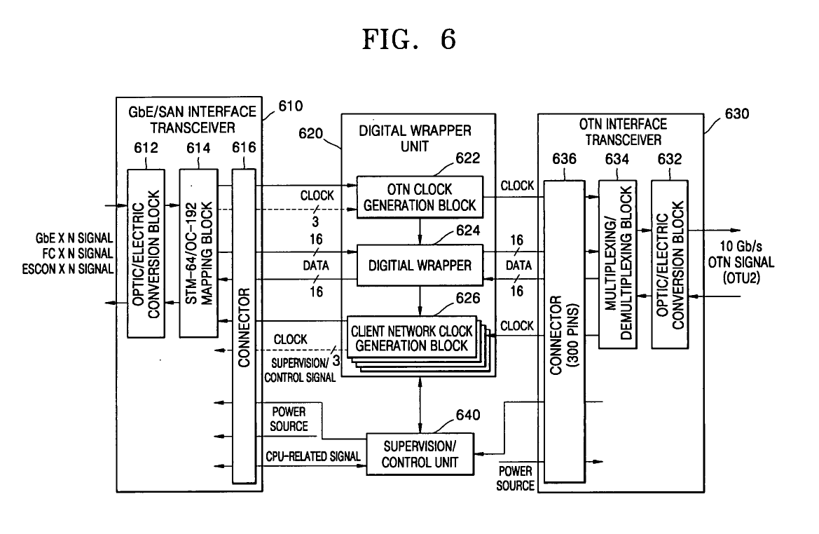

In addition, referring to FIG. 6, when a GbE/SAN interface transceiver 610 including an STM-64/OC-192 mapping block 614 as the client network interface transceiver 310 is mounted on the optical transponder 300. The STM-64/OC-192 mapping block 614 maps N GbE or SAN signals having a comparatively low speed into an STM-64/OC-192 signal by performing a generic framing procedure (GFP) and a concatenation procedure. The 16 data and the one clock signal mapped and multiplexed into the STM-64/OC-192 signal are transmitted from the STM-64/OC-192 mapping block 614 to the digital wrapper unit 620 and a supervision/control unit 640. Thus, as shown in FIG. 6, only one client network clock generation unit of the four client network clock generation units 623 is used, and a CPU-related signal is used.

As described above, six data and four clock signals are connected between the client network interface transceiver 310 and the digital wrapper unit 320, so as to receive various types of client signals. In addition, a supervision/control signal and the CPU-related signal are connected between the client network interface transceiver 310 and the supervision/controlling unit 340. Furthermore, various types of client signals can be received by designing a connection unit of the client network interface transceiver 310 so that a power source is supplied to the client network interface transceiver 310.

The digital wrapper unit 320 may be used in two cases: one case where an STM-64/OC-192 signal is input into the digital wrapper unit 320 and the other case where four STM-16/OC-48 signals are input thereinto. When the STM-64/OC-192 signal is input into the digital wrapper unit 320, each one of the OTN clock generation block 322 and an SDH clock generation block 324 is necessary. However, when the four STM-16/OC-48 signals are input into the digital wrapper unit 320, the STM-16/OC-48 signal is in an asynchronous state. Thus, four client network clock generation blocks are necessary. Thus, when the digital wrapper unit 320 is designed to have four client network clock generation blocks, the digital wrapper unit 320 is designed to use one client network clock generation block among the four client network generation blocks when interfacing the STM-64/OC-192 signal. In this case, the OTN clock generation block 322 generates a clock signal for mapping, and the client network clock generation block 326 generates a clock signal for demapping.

The OTN interface transceiver 330 is a unit into which the OTU2 optical signal is input or which outputs the OTU2 optical signal. The OTN interface transceiver 330 includes a multiplexing/demultiplexing block 332, an optic/electric conversion block 334, and a connector 336. The configuration and operation of the OTN interface transceiver 330 are similar to those of the client network interface transceiver 310, and thus detailed descriptions thereof will be omitted.

The supervision/control unit 340 supervises/controls the operation of each element even when the STM-16/OC-48 signal and the GbE/SAN signal as well as the STM-64/OC-192 signal are input into the supervision/control unit 340. In addition, the supervision/control unit 340 makes CPU communication with the client network interface transceiver 310 by receiving the CPU-related signal from the client network interface transceiver 310. In addition, firmware of the supervision/controlling unit is used to re-provisioning hardware according to types of client signals.

As described above, in the optical transponder which can be reconfigured in accordance with various types of client networks according to the present invention, a functional unit commonly needed in the optical transponder is shared and only a client network interface transceiver is replaced from the optical transponder according to types of client signals such that hardware is re-provisioned in response to the client signals, thereby configuring a new optical transponder. Thus, a communication service provider purchases not the entire optical transponder but the client network interface transceiver when the optical transponder should be replaced with another one owing to changed demand in interfacing client signal such that purchasing costs are reduced. In addition, an optical transponder manufacturer can reduce costs for manufacturing and managing various types of optical transponder PCBs.

While the present invention has been particularly shown and described with reference to exemplary embodiments thereof, it will be understood by those skilled in the art that various changes in form and details may be made therein without departing from the spirit and scope of the invention as defined by the following claims.

1. An optical transponder comprising:
a client network interface transceiver multiplexing a client signal transmitted from a client network or demultiplexing a signal transmitted from an optical transmission network and outputting the multiplexed signal and the demultiplexed signal;
a digital wrapper mapping an STM-64/OC-192 signal or a plurality of STM-16/OC-48 signals input from the client network interface transceiver into an OTU2 signal or demapping the OTU2 signal into the STM-64/OC-192 signal or the plurality of STM-16/OC-48 signals, including a plurality of client network clock generation units to provide a second clock signal needed in the client network interface transceiver;
an OTN interface transceiver transmitting the OTU2 signal input from the optical transport network to the digital wrapper or transmitting the OTU2 signal input from the digital wrapper to the optical transport network; and
a supervision/control unit initializing and re-provisioning hardware according to types of client signals input into the client network interface transceiver from the client network and supervising performance of each element and occurrence of errors,
wherein the client network interface transceiver includes a connector comprising a first connection terminal providing a unit transmitting and receiving a plurality of first clock signals, a plurality of second clock signals, and a plurality of data signals to and from the digital wrapper; a second connection terminal providing a unit transmitting and receiving a supervision/control signal and a CPU-related signal to and from the supervision/control unit; and a power source terminal providing a unit to which a power source is supplied.

2. The optical transponder of claim 1, wherein the client network interface transceiver can be replaced through a front panel of the optical transponder line card in accordance with types of client networks, and the transponder can be re-provisioned by the supervision/control unit.

3. The optical transponder of claim 1, wherein when the client signal input into the client network interface transceiver is the STM-64/OC-192 signal, the supervision/control unit activates a first clock signal link of a plurality of first clock signal links via which the first clock signal is transmitted supplied to the digital wrapper from the client network interface transceiver, controls performance of each element to drive a client network clock generation unit of the plurality of client network clock generation units of the digital wrapper, and deactivates a CPU-related signal link via which the CPU-related signal is transmitted between the client network interface transceiver and the digital wrapper.

4. The optical transponder of claim 1, wherein when the client signal input into the client network interface transceiver is the STM-16/OC-48 signal, the supervision/control unit activates at least four first clock signal links of a plurality of first clock signal links via which the first clock signal is transmitted supplied to the digital wrapper from the client network interface transceiver, controls performance of each element to drive at least four client network clock generation units of the plurality of client network clock generation units of the digital wrapper, and deactivates a CPU-related signal link via which the CPU-related signal is transmitted between the client network interface transceiver and the digital wrapper.

5. The optical transponder of claim 1, wherein when the client signal input into the client network interface transceiver is a GbE signal or an SAN signal, the supervision/control unit activates a first clock signal link of a plurality of first clock signal links via which the first clock signal is transmitted supplied to the digital wrapper from the client network interface transceiver, controls performance of each element to drive a client network clock generation unit of the plurality of client network clock generation units of the digital wrapper, and activates a CPU-related signal link via which the CPU-related signal is transmitted between the client network interface transceiver and the digital wrapper.

6. The optical transponder of claim 1, wherein the client network interface transceiver includes a mapping block mapping N GbE or SAN signals input into the client network interface transceiver from the client network into the STM-64/OC-192 signal by performing a generic framing procedure (GFP) or a concatenation procedure.
